(19) United States
(12) Patent Application Publication
(10) Pub. No.: US 2023/0267324 A1
(43) Pub. Date: Aug. 24, 2023

(54) Metrology by Neural Networks

(71) Applicant: The University of Chicago, Chicago, IL (US)

(72) Inventors: Seyed Alireza Seif Tabrizi, Adelphi, MD (US); Changhun Oh, Chicago, IL (US); Tao Hong, San Jose, CA (US); Liang Jiang, Chicago, IL (US)

(73) Assignee: The University of Chicago, Chicago, IL (US)

(21) Appl. No.: 18/088,252

(22) Filed: Dec. 23, 2022

Related U.S. Application Data
(60) Provisional application No. 63/294,018, filed on Dec. 27, 2021.

(51) Int. Cl. G06N 3/08

(52) U.S. Cl. CPC G06N 3/08

(57) ABSTRACT

A machine learning method for model-free inference of target physical parameters from a metrology dataset is generally disclosed. The disclosed method is particularly applied to atomic interferometry for sensing/measuring physical quantities such as acceleration and rotations from measured atomic interference patterns. The method operates without a need for an exact measurement-dependent mathematical/analytical model and without a need for explicit knowledge of instrumental error processes that affect the measurement. The disclosed method is based on neural networks that are trained or calibrated to learn to simultaneously estimate the target physical quantities of interest and their measurement uncertainties. It extends the applicability of a metrology when instrumental precision is limited, and noise and imperfections are present.

### CROSS REFERENCE

This patent application is based on and claims the benefit of priority to U.S. Provisional Pat. Application No. 63/294,018, filed on Dec. 27, 2021, which is herein incorporated by reference in its entirety.

### GOVERNMENT FUNDING

This invention was made with government support under Government Grant Nos. W911NF-18-1-0020, W911NF-18-1-0212, and W911NF-16-1-0349 from the U.S. Army Research Office; Government Grant Nos. FA9550-19-0399 and F9550-21-1-0209 from the U.S. Air Force Office of Scientific Research; Government Grant Nos. EFMA-1640959, OMA-1936118, and EEC-1941583 from the U.S. National Science Foundation. The government has certain rights in the invention.

### FIELD OF THE INVENTION

This disclosure relates generally to metrology assisted by artificial intelligence, and specifically to improving measurement precision and removing requirement of knowledge of at least some instrumental parameters in advanced metrology by data pattern recognition using neural networks.

### BACKGROUND

For applications in metrology, it is important to both estimate a set of target physical parameters of interest from a measurement dataset and to characterize errors in those estimates. Traditional model-dependent extraction of the target physical parameters of interest from the measurement dataset generally requires precise knowledge of a set of instrumental parameters and measurement conditions. In may applications, these model-dependent data analytics may not be capable of quantifying measurement uncertainty of the target physical parameters.

### SUMMARY

This disclosure relates generally to metrology assisted by artificial intelligence, and specifically to improving measurement precision and removing requirement of knowledge of at least some instrumental parameters in advanced metrology such as atomic interferometry by data pattern recognition using neural networks.

For example, a machine learning method and system for model-free inference of target physical parameters from a metrology dataset is generally disclosed. The disclosed method and system is particularly applied to atomic interferometry for sensing/measuring physical quantities such as acceleration and rotations from measured atomic interference patterns. The method operates without a need for an exact measurement-dependent mathematical/analytical model and without a need for explicit knowledge of instrumental error processes that affect the measurement. The disclosed method is based on neural networks that are trained or calibrated to learn to simultaneously estimate the target physical quantities of interest and their measurement uncertainties. It extends the applicability of a metrology when instrumental precision is limited, and noise and imperfections are present.

### BRIEF DESCRIPTION OF THE DRAWINGS

For a more complete understanding of the invention, reference is made to the following description and accompanying drawings, in which:

FIG. 1 illustrates an example data flow for predicting physical parameters and their uncertainties from noisy metrology measurements using a pre-trained neural network;

FIG. 2 illustrates an example training process for the neural network of FIG. 1;

FIG. 3 illustrates operational principles of an example atomic interferometer;

FIG. 4 illustrates example data and logic flow for extracting rotation, acceleration and other physical parameters from an atomic interferogram;

FIG. 5 illustrates example architecture of the neural network of FIG. 1;

FIG. 6 illustrates prediction of a physical rotation parameter based on a pre-trained neural network in comparison to other measurement model-based approaches;

FIG. 7 illustrates predicting temperature of an atomic cloud in an atomic interferometer from an atomic interferogram using a pre-trained neural network;

FIG. 8 illustrates prediction of a physical rotation parameter based on a pre-trained neural network in presence of acceleration in comparison to other measurement model-based approaches; and

FIG. 9 illustrates prediction of a physical acceleration parameter based on a pre-trained neural network in comparison to other measurement model-based approaches.

### DETAILED DESCRIPTION

### Using a Pre-Trained Neural Network to Process Metrology Datasets

In some physical metrology systems using advanced instrumentation techniques for measuring or sensing one or more physical parameters (e.g., radio-frequency spectroscopy, atomic interferometry, and the like), a number of instrumental and measurement condition settings may need to be configured in order to perform the desired measurement. For example, an optical source may need to be controlled or tuned to a particular stable wavelength in a metrology system based on optical spectroscopy. For an other example, a cold atomic cloud with particular spatial and momentum profile may need to be generated in order for an atomic interferometer to function as a rotation or acceleration sensor.

Parameters associated with these measurement settings in the metrology system may be referred to as instrumentation parameters or instrumental parameters as opposed to the one or more target physical parameters being measured. Some of these instrumentation parameters may not be easily obtained. For some other instrumentation parameters, while they may be directly or indirectly set and thus known in a particular measurement, they may only be controllable to a certain precision, both in terms of random fluctuation (random error) and systematic error. The random or systematic errors in these instrumentation parameters, in conventional metrology, would usually affect the precision of the actual final measurement of the one or more target physical parameters. Such random or system errors and the resulting uncertainty in the final determination of the one or more target physical parameters being measured may thus strongly depend on the quality/stability and instrument cost of the metrology system.

In such an advanced metrology system, the one or more target physical parameters are usually indirectly extracted from a set of complex measurement datasets (e.g., optical spectra in an metrology system based on optical spectroscopy, and an atomic interferogram in a metrology system based on atomic interferometer, as described in further detail below). Such complex measurement datasets usually contain a multitude of information from which the one or more target physical parameters may be extracted. The extraction process usually involves a set of data analytics that rely on one or more mathematical, analytical, and numerical models in addition to the measured complex dataset. These models bridge between the complex measurement datasets and the target physical parameters being extracted/measured. They are thus measurement-dependent. The instrumentation parameters described above may be part of the these models. They must be prescribed with known value from the measurement in the analytical model in order to extract the one or more target physical parameters being measured.

The errors in the instrumentation parameters (either random or systematic), as included in the analytical or numerical models, would then cause measurement errors in the extracted value for the target physical parameters in comparison to their true values. In addition, the one or more target parameters may randomly fluctuate and thus their measurements may be intrinsically uncertain regardless of the errors in the other instrumentation parameters. The disclosure herein uses the term “uncertainty” to refer to an overall measurement precision limitation as a result of both the random fluctuation of the target physical parameters (e.g., a rotation parameter to be measured may not be stable during the measurement) and errors in the other instrumentation parameters.

In many situations, the complex measurement datasets contain information more than sufficient for the extraction of the one or more target physical parameters. For example, effects of random errors and/or systematic errors of the instrumental parameters may be embedded in the complex measurement datasets. Such effects may be recognizable from the complex measurement dataset and thus may in principle be removable or reducible from the complex measurement dataset. Yet the traditional analytical or numerical models for the extraction of the target physical parameters may only be based on various physical or mathematical principles underlying the measurement process and are thus incapable of identifying and isolating features in the complex measurement datasets that are attributable to the random or system errors of the the instrumental parameters or attributable to the random fluctuation of the target physical parameters.

In the disclosure below, example implementations are described for a model-less extraction of one or more target physical parameters from a set of complex measurement datasets from a metrology system such that the effects from instrumental errors (random and/or systematic) are removed or reduced. As such, extraction of the target physical parameters are performed with higher precision than afforded by a model-based extraction process under the same error conditions for the instrumental parameters. In the particular embodiments described in further detail below, the extraction process of the target physical parameters may be based on machine-learning. For example, the extraction process may be based on a pre-trained neural network. The pre-trained neural network takes the set of complex measurement datasets as input, preforms forward propagation, and produces an output including the predicted values of the target physical parameters. It is noted that a pre-trained neural network may be considered a “model” in a general sense. However, it is a model that purely rely on recognition of patterns and correlations within the measurement datasets. The term “model” is used in this disclosure to narrowly refer to analytical or numerical model that depend on the measurement process and the physical or mathematical principles therein rather than the measured data pattern. Thus, the neural network approach is considered “model-less” or “model-free”.

Such a neural network may be pre-trained such that it is capable of recognizing data patterns and correlations in an input complex measurement dataset that relates to the target physical parameters being measured but are independent of random and/or systematic errors in the instrumental parameters described above. Such capability may be obtained through the training processes. For example, training datasets may be generated by a precision and stable metrology system in which the instrumental parameters are precisely controlled and stabilized. Such training dataset thus provides a relatively clean representation of correlation between the training datasets of the known ground truth of the target physical parameters. Such correlation may be learned by the neural network through the training process. The trained neural network thus may be capable of discriminate against effect of random and/or system errors of the instrumental parameters in an input dataset produced by a less precise (lower quality) metrology system.

The training process using measurement datasets from a precision metrology system thus effectively provides a “calibration” capability. In other words, the neural network is trained or calibrated by a more expensive, stable and better-controlled metrology system. The training and calibration process enables the neural network to discriminate against errors. As such, the trained neural network may then be deployed to process measurement datasets from lower-precision (less stabilized and thus cheaper) or noisier metrology system to extract the target physical parameters with improved precision in comparison to the extraction processes involving analytical or numerical models described above.

Such neural network may be constructed to additionally output measurement uncertainties for the target physical parameters. The neural network is thus trained to capture measurement uncertainties (resulting from, e.g., instrumental errors and other uncertainty sources) from an input complex dataset. The training process thus involves determining/recognizing the effects of noises on the measurement of the target physical parameters in the training complex datasets. The measurement uncertainties may be embedded in some correlations across training datasets (as instrumental and other noises would vary across measurement datasets generated for training). The training process of the neural network would be capable of capturing such cross-dataset correlations and determining measurement uncertainty in a single input dataset after the neural network is trained. Such capability may be achieved by constructing an appropriate loss function targeting a joint optimization of the predicted values for the target physical parameters as well as their uncertainties, as illustrated in detailed examples below.

In some example implementations, the training datasets may be alternatively or additionally generated from physical simulation of one or more model metrology systems. The simulation may be based on models developed using physical and mathematical principles underlying the metrology systems. Simulated measurement datasets may be generated under a set of ground truth values for the target physical parameters. In some implementations, random instrumental or other fluctuations may also be included to simulate noises. The simulated measurement datasets may be labeled with ground truth values of the target physical parameters used in the various simulation datasets for the training of the neural network.

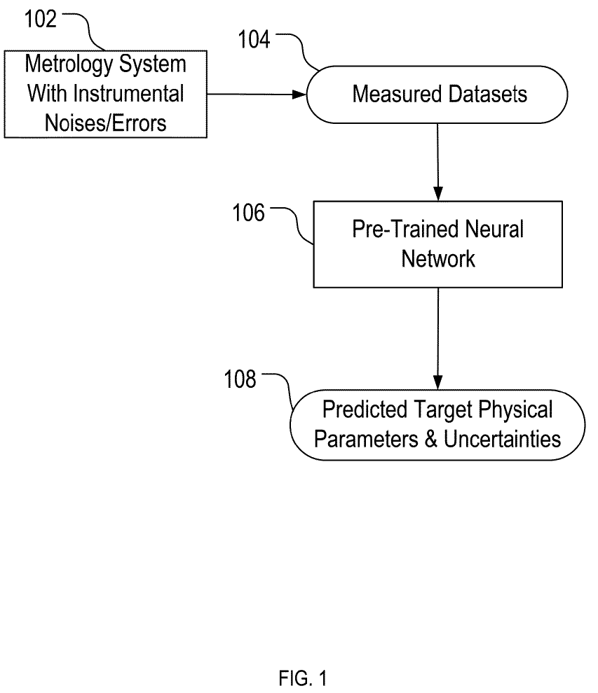

FIG. 1 illustrates an example process for metrology based on a pre-trained neural network. As shown in FIG. 1, a complex measurement dataset 104 may be generated by a metrology system 102 with instrumental noises or errors. Such instrumentation noises or errors may be random errors or systematic errors related to the settings and other instrumentation parameters of the metrology system 102. The complex measurement dataset 104 may then be input to a pre-trained neural network 106. The pre-trained neural network 106 may perform forward propagation of the complex measurement dataset 104 to generate a set of predicted target physical parameters and predicted measurement uncertainties of these target physical parameters, as shown by 108.

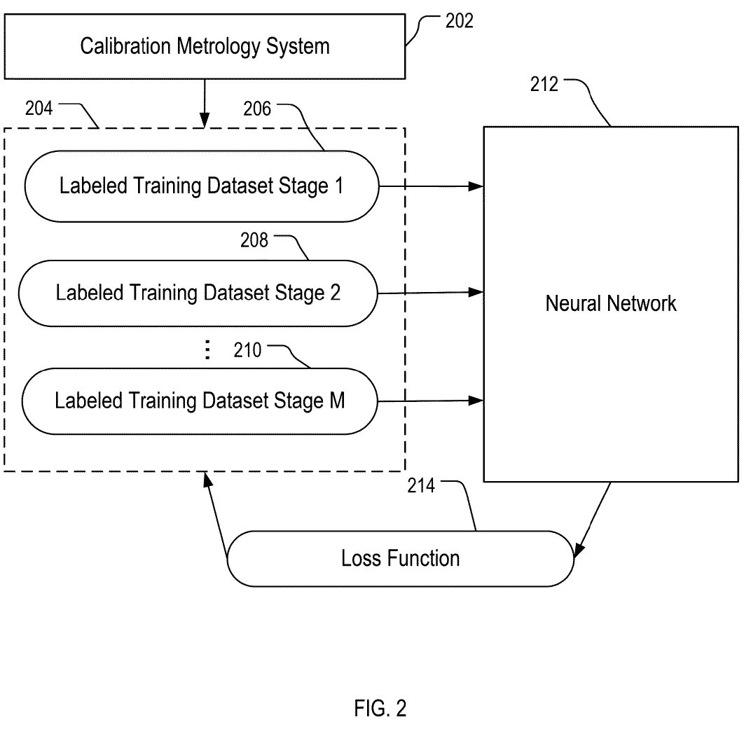

FIG. 2 further illustrates an example training process for the neural network of FIG. 1. As shown in FIG. 2, the training process first includes generation of training datasets 204 from a calibration metrology system 202 or from simulation. In some example implementations, the calibration metrology system 202 may include a higher-precision instrumentation for the metrology systems to which the neural network is to be applied. For an example neural network to be trained for general use in processing atomic interferogram, the calibration metrology system may correspond to a high-precision atomic interferometer. Such calibration atomic interferometer may be constructed to satisfy a set of precision standards. In order to satisfy the set of precision standards, the calibration atomic interferometer, as described in further detail below, may need to be constructed with sufficient precision and stability in terms of positional and momentum distribution of initial atomic cloud generation and launching, temperature stability of the atomic interferometer, wavelength, pulse area, and power stability of Raman laser pulses from various optical sources used to produce the optical beams for manipulating the atomic cloud, the various optical components used to manipulate the optical beams, and the like. In other words, an expensive standard-compliant system may be used as the calibration metrology system 202 for generating the training datasets 204 from real physical measurements. The optical beams may be generated using lasers in the form of Raman laser pulses, as described in further detail below.

To generate the training datasets, the calibration metrology system 202 may be operated to measure the set of target physical parameters with various ground-truth values. The ground true values may include both the nominal values and their uncertainties (fluctuations). For example, a testing environment may be configured and controlled with various values and uncertainties of the set of target physical parameters. The calibration metrology system 202 may then be used in the testing environment to generate measurement datasets. The measurement datasets together with the known target physical parameters of the testing environment and their uncertainties may then be used as the labeled training dataset 204. The training dataset, may be further divided into subsets for training, validation, and testing of the neural network 212. Further, as described above, the training, testing, and validating datasets may be alternatively or additionally generated by simulation.

The training process as illustrated in FIG. 2 may follow an iterative optimization process (e.g., gradient descent) for minimizing a predefined loss function 214. The loss function may be constructed in various forms. The loss function, generally may include components intended for minimizing prediction error in terms of a difference between the predicted nominal values and ground truths of the set of target physical parameters and may further include additional components intended for correctly predicting the uncertainties in extracting the target physical parameters. A particular example loss function used for training a neural network for use in atomic interferometry is described in further detail below.

In some metrology applications, more than one target physical parameters may be of interest. As such, it may be desirable to extract each of the more than one target physical parameters from a single measurement dataset using the neural network described above. In some example implementations, separate neural networks may be pre-trained for each of the more than one target physical parameters. The advantages of separately training neural networks for extracting different physical parameters and their uncertainties, for example, may include more adapted and more precise training of the neural networks and better/faster convergence. In some other example implementations, the more than one target physical parameters may be divided into subgroups, and a neural network may be constructed and trained for each of the subgroups of target physical parameters for joint predictions of the physical parameters and uncertainties within each subgroup.

In some situations, a particular target physical parameter may span a large value range. Training of a corresponding neural network holistically in a single process for the entire value range may be problematic. For example, the neural network trained in such a manner may not be able to provided sufficient relative precision for the target physical parameter at very small values, as the training may converge to a neural network that treats the target physical parameter at the same scale for both small and large values within the entire value range (while it may be preferable to provide better absolute precision at lower values).

In some example implementations, as shown in FIG. 2, the training of the neural network 212 may be staged in order to provide the neural network with better precision at low parameter values. Specifically, the training datasets may be divided into a predefined number of subsets within the value range of the target physical parameter according to the ground-truth values. Each subset of training datasets corresponds to one value sub-range within the entire value range of the target physical parameter. The training process may start with the subset of training datasets with the lowest values, shown as 206 in FIG. 2. Such training stage is referred to as “stage 1”. The stage 1 training may involve iteratively optimizing the loss function within the stage 1 value range until the neural network 212 converges. Then the training continues to the next value range shown as 208, referred to as “stage 2”. Stage 2 training may start with the neural network already trained in stage 1 and further optimize the neural network to minimize the loss function 214 within the second value range and all lower value ranges collectively until the neural network again converges. The process continues (as show by 210 for stage M) until all values ranges are trained. The final stage would involving training of the neural network using training datasets associated with the entire value range of the target physical parameter.

In the additional disclosure below, an example implementation of the underlying principles described above in an metrology application using an atomic interferometer is described in detail. In such an application, a measurement dataset may be generated as an atomic interferogram. Target physical parameters such rotation and acceleration may be extracted from the measured atomic interferogram. The atomic interferometer, for example, may be disposed in a measurement environment represented as a non-inertia reference frame. The non-inertia reference frame may angularly rotate or linearly accelerates related to an inertial reference system. The speed of angular rotation or the acceleration may be the target physical parameter to be measured. While atomic interferometer-based metrology is the focus in the disclosure below, the general underlying principles above, however, are not so limited, and are applicable to many other metrology systems for a model-less extraction of nominal values and uncertainties of target physical parameters with improved precision from noisy instruments having a low-quality.

### Atomic Interferometer

Atom interferometry represents an example of a quantum technology that has already found application beyond the proof-of-principle experiments. These interferometers provide an exceptionally accurate metrology systems that can be used to measure quantities such as gravitational field, acceleration, and angular momentum (rotation) .

Operating and interpreting the results of an interferometer in a traditional way may require precise calibration and characterization, and knowledge of the instrumentation parameters. This is typically achieved through modeling the interferometry system and the noise processes affecting the device. Therefore, for such model-dependent estimation procedures using experimental data, it is crucial to calibrate and stabilize experimental/instrumentation parameters to guarantee that the model correctly describes the experiment and that the estimate of the target physical parameters being measured from it is correct. Especially for atom interferometer, more specifically point source interferometer (PSI), it may be critical to precisely know and stabilize various parameters such as initial atomic cloud size and temperature of the atomic cloud since those parameters determine how to interpret measurement outcomes to extract physical parameters of interest. Therefore, a limiting source of the interferometer’s precision includes imperfections in the inference model that is used to connect the measurements to the physical quantities of interest.

As described above, instead of using instrumentation dependent inference modeling, machine learning techniques based on detecting measurement data pattern may be developed to infer the physical parameters from interferograms generated by an atom interferometer. In particular, neural networks may be used to infer the rotation vector and acceleration together with their measurement uncertainties in an atomic interferometer. Such a method may be superior to other inference model based data analytics ethology, such as Fourier-based analysis of the interference patterns, and does not require detailed knowledge of the specifications of the experiment. As further described below, at least in some value ranges, the neural network approach appears better than, for example, Fourier-based algorithms or state-of-the-art phase unwrapping algorithms. The neural network approach only requires the ability to produce interference patterns for known random physical parameters during the training process. Such an approach enables compensation of limitations in the hardware using machine learning algorithms and are also useful in correcting systematic errors and biases in the experiment in a reliable and self-consistent manner.

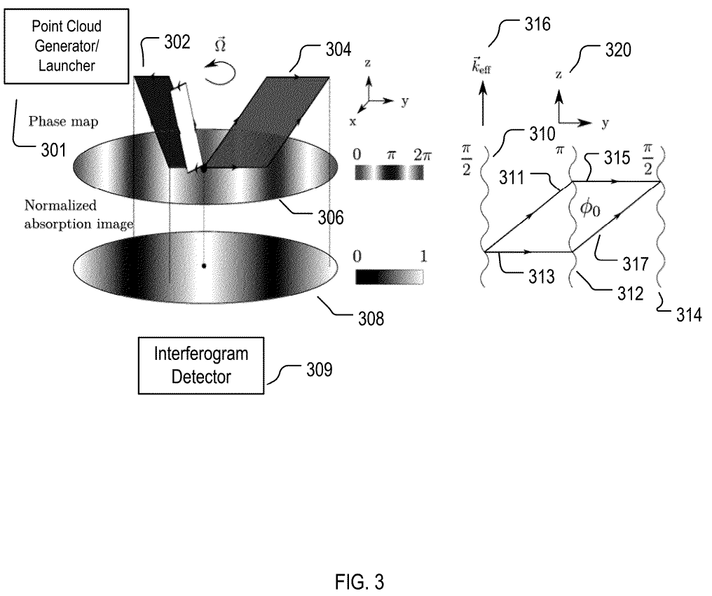

FIG. 3 illustrates the underlying principles using a PSI in an atomic interferometer for estimating rotation. Contrary to conventional atomic interferometer in which the thermal expansion of an atomic cloud is detrimental for precise measurement, PSI takes advantage of the thermal expansion of an atomic cloud to have a broad velocity distribution for sensing a velocity-dependent signal such as rotation. Since individual atoms experience the rotation signal differently depending on their spatial profile, each atom accumulates a different phase. In other words, each atom constitutes a distinct atom interferometer. Thus, by examining its output population or intensity distribution of the ensemble, intensity images or interferograms may be obtained and used to extract physical parameters of interest.

For example, PSI may operate as follows. First, N atoms may be initially prepared by a point cloud generator and launcher 301 of FIG. 3 in a ground state. Here, the ensemble of N atoms constitutes a cloud with some initial cloud size and a velocity distribution characterized by a temperature. It may be assumed that atoms’ initial position and velocity follow a Gaussian distribution with a standard deviation of Σᵢ and Σᵥ.

In an example Mach-Zehnder type of interferometry arrangement, after launching the atoms up along a z-axis by the point cloud generator and launcher 301, a π/2 pulse 310 is applied to the atoms to make a superposition between two trajectories for each atom shown as trajectory 302 and trajectory 304 in FIG. 3. The π/2 pulse 310 may be implemented optically via electronic to momentum transfer. In other words, optical excitation leads to change of atomic center of mass motion into a momentum superposition state. Each atom thus follow two possible trajectory after the π/2 pulse 310 is applied, as further shown by 311 and 313.

The atoms then freely evolve for time T_{free}, and a π pulse 312 is then applied to the atoms to inverse the the two trajectories, as shown by 315 and 317 if FIG. 3. After another free evolution for time T_{free}, a π/2 pulse 314 is again applied to the atoms. The atoms following two different trajectories accumulate different phases, and are thus allowed to interfere at same spacial locations, generating an interferogram reflecting the atomic interference due to the phase variation as shown by 306, which is detected as absorption image 308 by an atomic interferogram detector 309.

During a free fall along the different trajectories, the atoms may experience a rotation and acceleration, characterized by angular velocity vector Ω̅ and acceleration vector α̅, which affect a phase difference between two trajectories. The rotation and acceleration information is thus embedded in the detected interferogram. For example, the phase difference of an atom between the two trajectories induced by the rotation and acceleration α̅ may be written as

$${ϕ}_{0} \left(\vec{r}\right) = \frac{2 {T}_{\text{free}}^{2}}{{T}_{\text{ex}}} \left(\vec{Ω} \times \vec{r}\right) ⋅ {\vec{k}}_{\text{eff}} + {\vec{k}}_{\text{eff}} ⋅ \vec{a} {T}_{\text{free}}^{2} , \qquad \text{(1)}$$

where r̅ represents the displacement vector of the atom’s position, Tₑₓ denotes the total expansion time from launching to detection, and k̅ₑ_{ff} represents the effective wavevector.

The intensity distribution (or population of atoms in an excited state) or the interferogram at the imaging plane (perpendicular to z axis of 320) is detected by the interferogram detector 309, and may be further used to estimate the rotation vector. For example, the probability to detect an excited state of an atom is given by cos²[ϕ₀(r̅)/2].

Taking into account the ensemble of N atoms, the intensity distribution over r̅_{f} on the image plane may be written as:

$$I \left({\vec{r}}_{f}\right) = N \frac{exp \left(- \frac{{\vec{r}}_{f}^{2}}{2 {\text{Σ}}_{f}^{2}}\right)}{{\left(2 π\right)}^{3 / 2} {\text{Σ}}_{f}^{3}} \frac{1 + c \left(\vec{Ω}\right) cos \left({\vec{k}}_{Ω} ⋅ {\vec{r}}_{f} + φ\right)}{2} . \qquad \text{(2)}$$

Here,

$$c \left(\vec{Ω}\right) ≡ {c}_{0} exp \left[- \frac{2 {T}_{\text{free}}^{4} {k}_{\text{eff}}^{2}}{{T}_{\text{ex}}^{2}} {Ω}^{2} \left(1 - {\text{Σ}}_{i}^{2} / {\text{Σ}}_{f}^{2}\right)\right] \qquad \text{(3)}$$

represents a fringe contrast, where Ω denotes the magnitude of

$$\vec{Ω} , {\text{Σ}}_{f} ≡ \sqrt{{\text{Σ}}_{i}^{2} + {\text{Σ}}_{υ}^{2} {T}_{\text{ex}}^{2}}$$

represents the final cloud size, φ represents an offset including the induced phase from acceleration, and

$${\vec{k}}_{Ω} ≡ \frac{2 {T}_{\text{free}}^{2} {k}_{\text{eff}}}{{T}_{\text{ex}}} \left(1 - {\text{Σ}}_{i}^{2} / {\text{Σ}}_{f}^{2}\right) Ω \hat{n} , \qquad \text{(4)}$$

where n̂ is a unit vector perpendicular to Ω̅ and k̅_{eff}. Here, is may be assumed that the image plane is xy-plane so we let r̅_{f} = (x,y) and that the wavevector is along z-direction, i.e., k̅_{eff} ∝ ẑ.

Thus, k̅_{Ω} lies on xy-plane, and can be treated as a vector on xy-plane from now on. Such a setting allows for a measurement of Ωₓ and Ω_{y}. It may also be assumed that acceleration α̅ is along z-direction and determines φ₀ as the acceleration-induced phase.

It can be seen from the relationship in Eq. (4) that the angular velocity of interest can be inferred from the fringe period of a phase image. In particular, Eq. (4) represents an inverse of the fringe period of the phase image expressed in Eq. (2). Therefore, in practice, if the Equations above are directly used, various experimental parameters within these questions need to be measured/determined to a sufficient accuracy or precision in advance and stabilized appropriately in order to attain a high accuracy estimate of the angular velocity (more precisely, the magnitude of the angular velocity Ω = ||Ω̅||₂) from the measured phase image or interferogram.

As can be seen from Eq. (4), the fringe period of the interferogram decreases (denser fringes) for an atomic cloud with wide velocity distribution (∑ᵥ). Further, the fringe contrast in the interferogram decreases for an atomic cloud with wide velocity distributions (∑ᵥ), as indicated by Eq. (3). As also indicated by Eq. (3), the fringe contrast in the interferogram also decreases for high angular velocity Ω. As such, the range of angular velocity Ω that can be measured is limited by experimental parameters.

For instance, when Ω is sufficiently large that |k̅_{Ω}|Σᵢ ≳ π, atoms at the same final position cancel out each other’s fringe and the fringe pattern gets blurred. Therefore, the finite cloud size ∑ᵢ limits the magnitude of angular velocity that can be measured.

### Sine and Cosine Image Generation

Based on the equations above, the probability of detecting an excited state, cos²(ϕ₀/2) is invariant under applying a negative sign, i.e., Ω̅↔–Ω̅, which causes ambiguity of estimation of a rotation vector. To unambiguously estimate a rotation vector Ω̅, K different interferogram images may be obtained or measured by applying offset phases δₙ = 2πn/K with n = 0,..., K – 1. The offset phases, for example, may be applied in the measurement by introducing corresponding accelerations.

For each offset phase δₙ, the intensity distribution can be written as (see Eq. (2))

$${I}_{n} \left(x , y\right) = A \left(x , y\right) + B \left(x , y\right) cos \left[ϕ \left(x , y\right) + {δ}_{n}\right] , \qquad \text{(5)}$$

where ϕ(x, y) = k̅_{Ω}·r̅_{f}. The images may then be processed to obtain sine and cosine images as

$$\begin{matrix}{I}_{s} \left(x , y\right) = \frac{2}{K} {\sum }_{n = 0}^{K - 1} {I}_{n} \left(x , y\right) sin {δ}_{n} \\ = - B \left(x , y\right) sin ϕ \left(x , y\right) ,\end{matrix} \qquad \text{(6)}$$

$$\begin{matrix}{I}_{c} \left(x , y\right) = \frac{2}{K} {\sum }_{n = 0}^{K - 1} {I}_{n} \left(x , y\right) cos {δ}_{n} \\ = B \left(x , y\right) cos ϕ \left(x , y\right) .\end{matrix} \qquad \text{(7)}$$

After the processing above, the background A(x, y) is naturally removed. As such, if a negative sign for a rotation vector is applied as Ω̅→–Ω̅, the sine image (Iₛ) now changes accordingly, and the output distribution can be discriminated between Ω̅ and –Ω̅

### Model-Based Fourier Transform Algorithm

The main task in interferometry is extracting ɸ from the interference patterns and subsequently infer the physical quantities that create the phase shift. Given the periodic nature of the interference patterns, in one of the model-based data analytics on the interferogram, Fourier transform (FT) may be employed as a baseline technique.

Specifically, let Iₜ(x, y) = I_{c}(x, y) – iIₛ(x, y) denote the complex valued interference pattern. It can be seen that Iₜ(x, y) = B(x, y) exp[iϕ(x, y)]. Taking the FT of this function then results in

$$\begin{matrix}{\tilde{I}}_{t} \left(x , y\right) = F \left[{I}_{t} \left(x , y\right)\right] \\ = exp \left[2 i φ - \frac{1}{2} {σ}^{2} \left({\left(\tilde{x} - {Ω}_{x}\right)}^{2} + {\left(\tilde{y} - {Ω}_{y}\right)}^{2}\right)\right] ,\end{matrix} \qquad \text{(8)}$$

where F is the FT operator, and x̃ and ỹ are the Fourier variables. Therefore, under the ideal conditions, the Fourier transform of the image is a displaced Gaussian function that its center provides the information about Ω̅, and the overall phase of the function reveals φ.

### Model-Based Phase Unwrapping Algorithm

Another method to extract physical quantities from intensity images Iₛ(x, y) and I_{c}(x, y) in Eqs. (6) and (7) is to convert the images into a phase map ϕ(x, y) and employ it to measure the physical quantities of interest. Specifically, a phase map may be first determined by using the relation ϕ(x, y) = atan2(Iₛ,I_{c}) + 2nπ with an integer n. After this procedure, phases at each point are confined between -π and π because of the periodicity. Therefore, the phase map is in general discontinuous, and an additional procedure, referred to as phase unwrapping for removing the discontinuity may be required.

A basic idea of such a method is to examine the discontinuity and adjust the 2π period to make the map continuous. After the phase unwrapping, a continuous phase map is obtained and may be used to extract k̅_{Ω} by fitting (e.g., 2D linear fit). Then k̅_{Ω} may be finally converted to the angular velocity vector using the relation of Eq. (4).

Since the final step above depends on other experimental parameters such as temperature, it may require accurate knowledge of these experimental parameters in advance and require a stabilization of these parameters during the experiment to reliably estimate rotation vector and acceleration. Otherwise, the conversion factors in Eq. (4) would be affected, resulting in a bias of the estimate of the physical parameters to be measured.

### Machine Learning for Predicting Target Physical Parameters and Their Uncertainties

For sensing applications, it is important to not only obtain an estimate of the quantity of interest but also obtain the uncertainty of that estimate. As described above, a machine learning framework, particularly a deep learning frame work, may be used to both improve accuracy in the estimation and also obtain an estimate of the error. To describe the general framework, let {(Xᵢ,y̅ᵢ)} denote the set of input-output pairs. The pairs correspond to the interferogram images and the corresponding physical parameters. The deep learning task is to train a network to estimate y̅ᵢ given access to the Xᵢ. A Gaussian likelihood with a diagonal covariance matrix may be used to capture the uncertainties in the data. Both the mean and the variance of the physical parameters may be output from the trained network, such as a trained convolutional neural network (CNN).

For example, the neural network may be represented by a function g_{θ} parameterized by θ, that takes the images Xᵢ as an input, performs a series of linear transformations combined with applications of nonlinear element-wise functions to the image and returns the mean µ̅ and the standard deviation of the variables σ̅, i.e., g_{θ}(X) = [µ̅,σ̅]. The neural network may be trained by finding the parameters θ that minimize the negative log-likelihood objective

$$L \left(θ\right) = {\sum }_{i , j} \frac{1}{2 {σ}_{i , j}^{2}} {\left({y}_{i , j} - {μ}_{i , j}\right)}^{2} + \frac{1}{2} log \left({σ}_{i , j}^{2}\right) + \text{const} . , \qquad \text{(9)}$$

where the sum is taken over the samples i (training images) and the dimension of the output indexed by j (the physical parameter indices).

In the loss function above, the mean squared error objective σ_{i,j} is obtained by making it dependent on input data rather than being a constant. This is crucial because it enables a qualification of the uncertainties in the estimate/prediction of the physical parameters of interest. The loss function above is a mere example. Other forms of loss functions may be constructed. Generally, the loss function may be constructed to balance the optimization of both the predicted target physical parameter relative to its ground truth and the predicted uncertainty that depends on input data, such that the optimization of the neural network takes into consideration of reasonable prediction of both the parameter values and corresponding uncertainties.

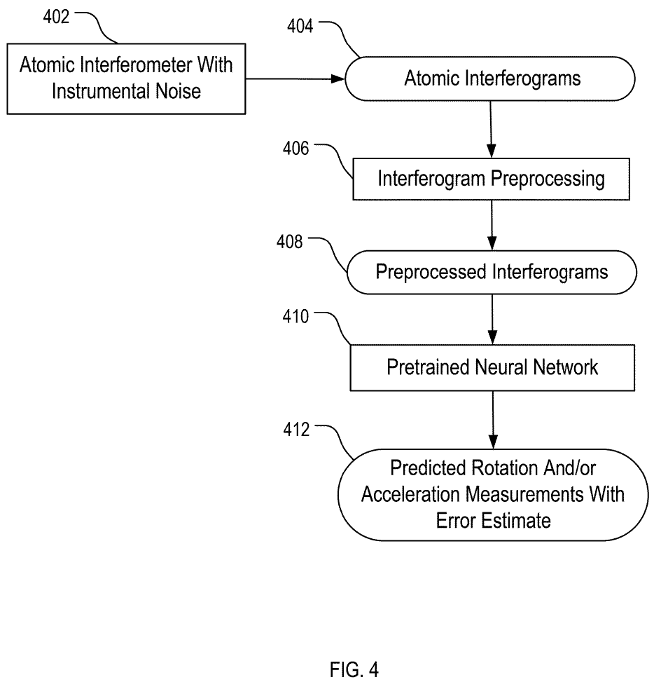

FIG. 4 illustrates an example process for training a neural network and use the trained neural network to predict a physical parameter at interest. As shown FIG. 4, one or more calibration atomic interferometers 402 may be used to generate raw training interferograms 404. The raw training interferograms 404 may be preprocessed as shown by 406 to generate preprocessed training images 408. The preprocessing, for example, may involve the generation of the sine and cosine images from the raw interferogram, as described above. The preprocessed training images 408 may then be used to iteratively train the neural network to obtain optimized network parameters that minimize the loss function described above, as shown by 410. The trained neural network may then be used to predict the target physical parameters of interest with their uncertainties, as shown by 412 of FIG. 4.

### Training Dataset Generation by Simulation

To verify the effectiveness of the deep-learning approach for predicting physical parameters from atomic interferograms, a set of training data are generated by simulation of atomic interferometry measurements. For simplification, the case of φ₀ = 0 is first considered. Non-zero φ₀ cases are dealt with later. Datasets consisting of samples of X = (I_{c}, Iₛ), with their corresponding y̅ = Ω̅ = (Ωₓ, Ω_{y}) labels are first generated by simulation.

The simulated input X may be discretized interference pattern represented by, for example, a 96 × 96 × 2 tensor, where the first two axes correspond to the spatial dimensions of the interferogram image, and the last axis corresponds to the sine and cosine part of the image. The data may be generated by choosing the angle and magnitude of the rotation vector Ω̅ of each sample uniformly at random from [0, 2π] and [0, 10], respectively. In this disclosure, Ω̅ may be in the units of degrees/second. The parameters of the instrumental setup may be chosen to correspond to those in real-world experiments. Specifically, as an atomic source, 10⁶ number of ⁸⁷Rb atoms with initial cloud size ∑ᵢ = 0.2 mm and 6_{µ}K of temperature is used. For the interferometer, an expansion time is set as Tₑₓ = 2.5 ms a free evolution time is set as T_{free} = 1.0 ms, and the wavevector is set as k_{eff} = 4π/780 nm.

To further simulate experimental errors in the instrumental parameters, a 20% temperature variations or fluctuation from a normal distribution for the atomic cloud is introduced. The simulated datasets are split into three subsets with a 60-20-20 ratio, referred to as the training, cross-validation, and test sets for training the CNN, tuning the CNN, and benchmarking the performance of the trained CNN, respectively. In a particular dataset generation process, a dataset with 176000 samples (or images) are produced.

For generation of training datasets from actual measurements by a precision or calibration atomic interferometer, such a precision atomic interferometer may be controlled to generate interferograms at different known angular velocities, accelerations and other physical parameters, and with stabilized instrumental parameters. In order to generate the measurement training datasets corresponding to the sine and cosine images described above, the phase can be controlled in the atomic interferometer instrumentation, by introducing controlled/known acceleration, or by, for example, controlling phases in the optical excitation Raman laser pulses used for generating the interfering trajectories according to predefined known values.

### Example CNN Network Architecture and Training

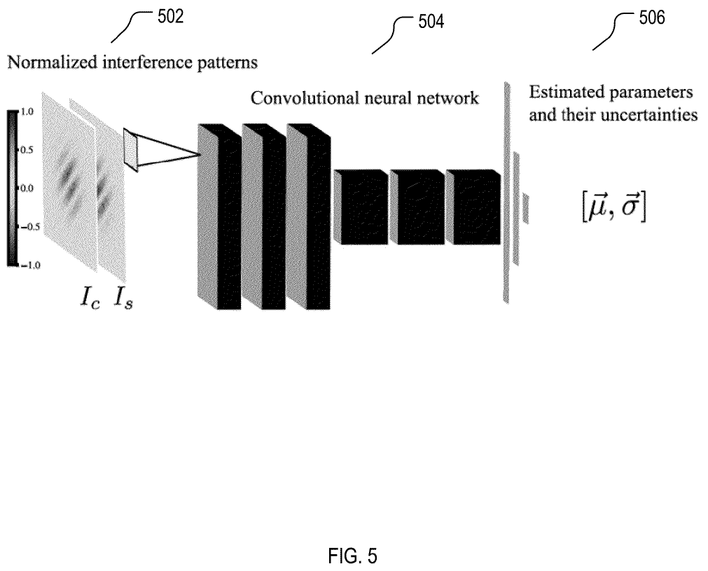

As an example network architecture, a CNN shown as 504 in FIG. 5 is designed to process input images 502 to generate predicted physical parameters and their uncertainty 506. The example CNN 504 of FIG. 5 includes first three convolutional layers have a 3 × 3 kernel with 64 channels, followed by a 2 × 2 maximum pooling layer. The example CNN 504 further contains next three convolutional layers similar to the first three convolutional layers except that they have 128 rather than 64 channels. These next three convolution layers are followed by another maximum pooling layer, with the output being flattened and fed to a fully connected layer with 128 neurons, followed by an output layer with 4 linear units. A rectifier, i.e., ƒ(x) = max(0,x), may be used as an activation function for all the various layers of the CNN except the output layer.

The loss function

$$L$$

such as the one indicated in Eq. (9) may be minimized over the samples in the training datasets in batches of size 128 using the Adam optimizer, with learning rate 10⁻⁴, and with other parameters appropriately chosen. The optimal kernel size, batch size, and learning rate are tuned using the cross-validation set described above. The staged training strategy described above in relation to FIG. 2 may be used. Specifically, the training starts by training the network for smaller values of Ω, and gradually increase the range, eventually to the full range. In particular, the training starts with 0 ≤ Ω < Ωₘₐₓ with Ωₘₐₓ = 1 and increase Ωₘₐₓ in increments of 1 every 30 epochs, up to Ωₘₐₓ = 10.

### Benchmarking of the Performance of the Example CNN

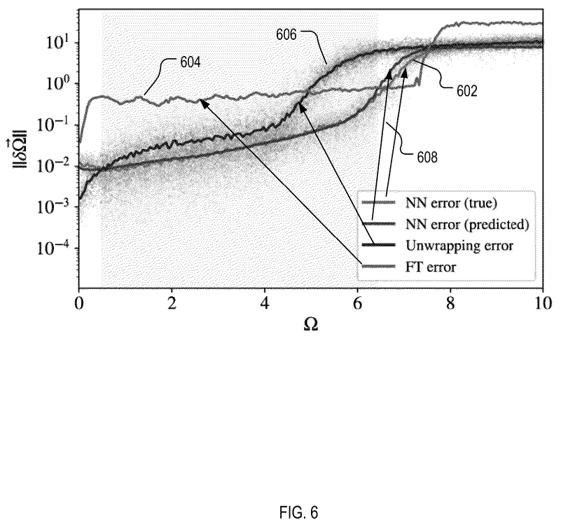

After the training of the CNN as described above, its performance may be benchmarked using the test datasets against other model-based approaches. FIG. 6 shows a comparison of the CNN performance in predicting the angular velocity in comparison to the FT and phase unwrapping approaches described above. In particular, estimation errors of

$$\vec{Ω} ,$$

defined as

$$\left‖δ \vec{Ω}\right‖ = {\left‖{\vec{Ω}}_{t r u e} - {\vec{Ω}}_{p r e d i c t e d}\right‖}_{2}$$

are compared.

$${\vec{Ω}}_{t r u e}$$

represents the true value of the angular velocity as used in the simulation of the test datasets. The neural network prediction error, the error of the FT estimation, the error of the phase unwrapping estimation of are shown by 602, 604, and 606, respectively for the angular velocity ranging from 0 to 10 degrees/second. A self-predicted uncertainty of the neural network’s estimate is also shown as 608. The self-predicted uncertainty 608 represents the predicted uncertainty of

$$\vec{Ω}$$

from the neural network.

FIG. 6 shows that the neural network provides a better performance in predicting

$$\vec{Ω}$$

compared to the other model-based approaches over a wide range of Ω values. As described above, for large Ω, the interference patterns in the interferograms get blurry because of the finite cloud size, and therefore performance of the CNN deteriorates, as indicated in FIG. 6 for high Ω values. Here, Ω = 7.75 corresponds to the point at which |k̅_{Ω}|Σᵢ ≳ π.

Moreover, the self-predicted uncertainty of the neural network, as shown by 608 in FIG. 6, matches its true error as indicated by 602. Part of the advantage of the network, as described above, can be traced back to its ability in finding clues about the instrumental errors (such as temperature variations) in the raw training data and using this information to generate better predictions. To confirm that such systematic error information in, for example, atomic cloud temperature, is indeed recognizable in the input dataset, a separate simpler neural network may be additionally trained to only predict the temperature (the temperature information is available in the simulated training datasets). As an example, the temperature-predicting neural network may only include two fully connected layers with 50 neurons followed by a single neuron output layer.

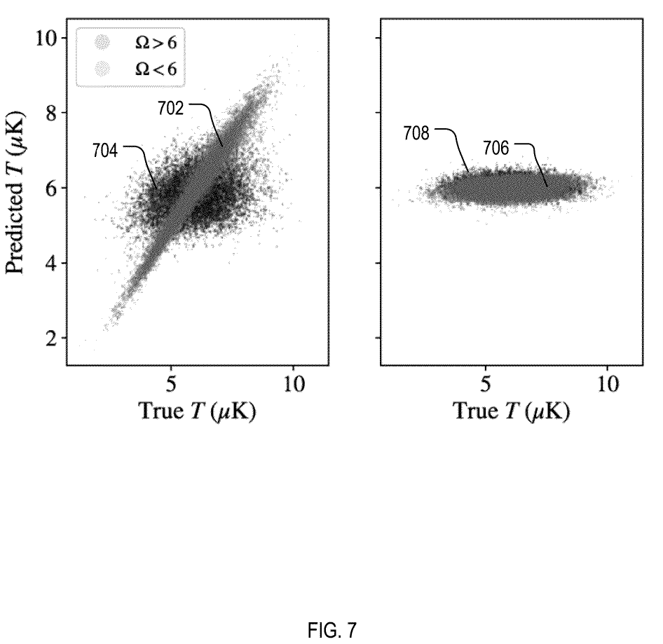

As shown in FIG. 7, such a neural network can be trained to distinguish temperature values in data at least for Ω < 6. Specifically, 702 of FIG. 7 shows that that for Ω < 6, the predicted temperature of the atomic cloud matches well with the actual temperature. The ability to correctly predict the temperature deteriorates for larger Ω < 6, as shown by 704 of FIG. 7. The procedure based on post-processed phase map data in the unwrapping algorithm is performed, with the derived temperature shown as 706 and 704 in FIG. 7 for Ω < 6 and Ω > 6, respectively. It can be seen that, unlike the neural network, the phase unwrapping procedure erases the temperature information from the data and is unable to extract system temperatures that match the true values.

### Non-Zero Phase Offset

In the disclosure above, it is shown that machine learning techniques can help reduce the errors in estimating the rotation vector from interference patterns and also provide prediction of its uncertainty. In the above examples, Ω̅ with φ₀ = 0 is considered. However, the neural network approach above may also be extended to the situation of non-zero φ₀.

As shown by the Eq. (1), the phase offset contains information about the acceleration. There are many manners in which machine learning may be used to learn both Ω̅ and φ₀ from input images/interferograms. In some example implementations, separate neural networks having similar neural network architectures as described above in relation to FIG. 5 may be used and trained to learn these parameters independently. While such an approach may not take full advantage of the similarities between the two tasks (rotation estimation and acceleration estimation) that could have been exploited by multi-task learning, it gives a simple and clear way to both learn the parameters and their uncertainties without introducing additional hyper-parameters (that defines neural network architecture and neuron connectives).

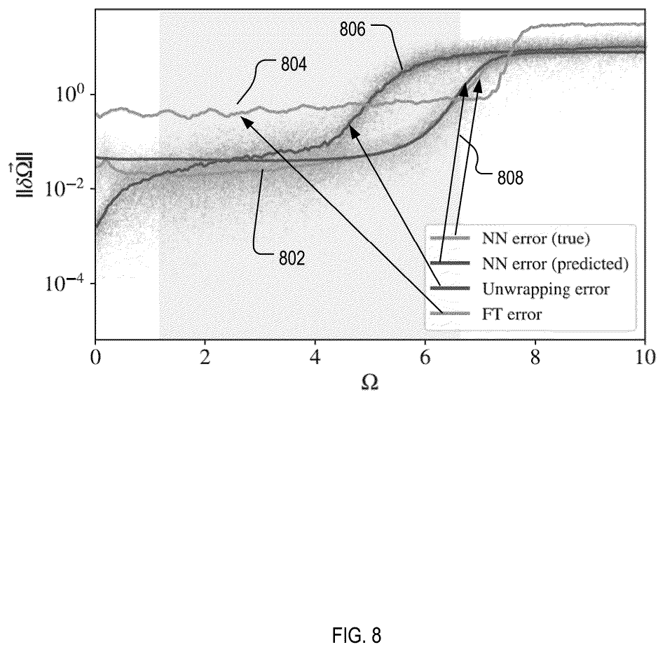

Example results for learning Ω̅ in the presence of a non-zero offset phase are shown in FIG. 8. Here the training strategy and hyper-parameters are similar to those for the case of the zero phase offset. The only difference is that the samples in the training dataset now feature a non-zero phase φ₀ that is chosen uniformly at random from [0, 2π]. In FIG. 8, the neural network prediction error, FT based estimation error, phase unwrapping estimation error, and neural network self-prediction error of the rotation vector Ω̅ are shown as 802, 804, 806, and 808, respectively. FIG. 8 shows that, similar to FIG. 6, using the CNN is advantageous in a wide range of parameters and the self-predicted estimation error is close to the actual error in the presence of non-zero phase offset.

For learning φ₀, a representation φ̅ = [cos(φ₀), sin(φ₀)] may be used. This representation eliminates the confusion and redundancy between angles such as 0 and 2π. Therefore, the same network architecture for estimating Ω̅ may be used to estimate φ̅ and its uncertainty.

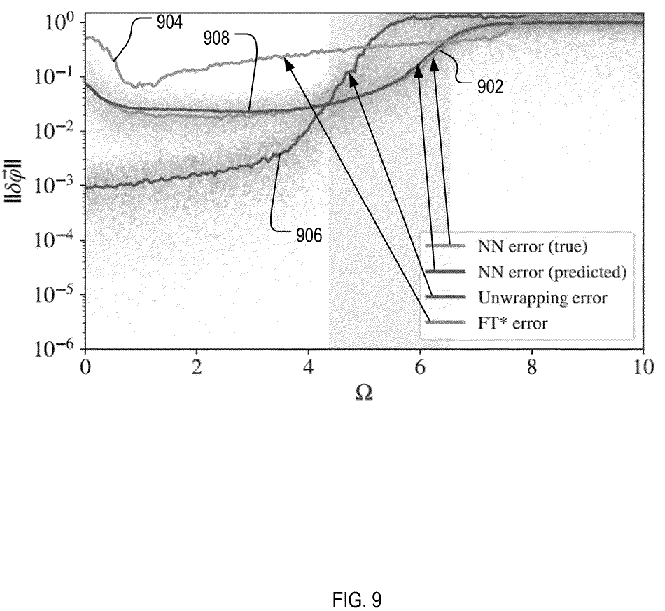

FIG. 9 shows the CNN results for predicting φ̅ in comparison with the model-based phase unwrapping and FT* approaches. Specifically, the neural network prediction error, FT* based estimation error, phase unwrapping estimation error, and neural network self-prediction error of the phase Ω̅ are shown as 902, 904, 906, and 908, respectively. While φ̅ can, in principle, be obtained from the phase information in FT* as shown in Eq. 8, due to finite-size effects the phase of the Fourier transform oscillates between ±φ₀, the sign of the phase cannot be reliably obtained. Therefore, for comparing the performance in FIG. 9, the FT* method error is shown as [cos(2φ₀), sin(2φ₀)] FIG. 9 shows that, in the intermediate regime, the CNN still outperforms the phase unwrapping algorithm in predicting φ̅. However, the range of its advantage is smaller compared to the case of estimating Ω̅. FIG. 9 further shows that the self-predicted error of φ̅ matches the true error in this case as well.

The various embodiments above relate generally to metrology assisted by artificial intelligence, and specifically to improving measurement precision and removing requirement of knowledge of at least some instrumental parameters in advanced metrology by data pattern recognition using neural networks. In one example implementation, a metrology method is disclosed. The metrology method includes receiving a measurement dataset originated by a metrology system characterized by an instrumental precision and a set of underlying metrology physical principles; retrieving a neural network configured to process the measurement dataset to generate a predicted value with predicted measurement uncertainty of a target physical parameter, the neural network being pre-trained based on a plurality of reference datasets for measuring the target physical parameter with known reference values and known uncertainties; and forward-propagating the measurement dataset through the neural network to generate the predicted value with the predicted measurement uncertainty of the target physical parameter having a precision higher than indicated by the instrumental precision.

In the implementation above, the instrumentation precision is associated with at least one systematic error of at least one instrumental component of the metrology system.

In any one of the implementations above, the instrumentation precision is associated with an instability of at least one instrumental component of the metrology system.

In any one of the implementations above, the plurality of reference datasets are generated via physical simulation based on the set of underlying metrology physical principles with the known reference values and known uncertainties of the target physical parameter.

In any one of the implementations above, the plurality of reference datasets are generated by one or more calibration metrology systems based on the set of underlying metrology physical principles and having reference precisions higher than the instrumental precision of the metrology system.

In any one of the implementations above, the metrology system comprises an atomic interferometer.

In any one of the implementations above, the measurement dataset comprises at least one atomic interferogram image.

In any one of the implementations above, the atomic interferometer comprises an atomic point source interferometer using an atomic cloud as a measurement medium.

In any one of the implementations above, the atomic interferometer is disposed in a non-inertia reference frame and the target physical parameter comprises an angular rotation or linear acceleration of the non-inertia reference frame relative to an inertia reference frame.

In any one of the implementations above, the instrumentation precision of the atomic interferometer is associated with at least an imperfection in controlling a temperature of the atomic cloud.

In any one of the implementations above, the instrumentation precision of the atomic interferometer is associated with at least an imperfection in controlling an optical manipulation of the atomic cloud in a generation of the measurement dataset.

In any one of the implementations above, the imperfection comprises at least one of an optical wavelength imperfection, an optical pulse area imperfection, and an optical geometric alignment imperfection.

In any one of the implementations above, the at least one atomic interferogram image comprises a set of sine and cosine images generated from a set of measured atomic from the metrology system with a predefined set of phase offsets.

In any one of the implementations above, the atomic interferometer is arranged in a Mach-Zehnder interferometry configuration.

In any one of the implementations above, a loss function for training the neural network comprises an optimization parameter representing measurement uncertainty of the target physical parameter, the optimization parameter being dependent on the plurality of reference datasets.

In some other example implementations, a computing system is disclosed. The computing system may include a memory for storing instructions and a processor for executing the instructions to receive a measurement dataset originated by a metrology system characterized by an instrumental precision and a set of underlying metrology physical principles; retrieve a neural network configured to process the measurement dataset to generate a predicted value with predicted measurement uncertainty of a target physical parameter, the neural network being pre-trained based on a plurality of reference datasets for measuring the target physical parameter with known reference values and known uncertainties; and forward-propagate the measurement dataset through the neural network to generate the predicted value with the predicted measurement uncertainty of the target physical parameter having a precision higher than indicated by the instrumental precision.

In any one of the implementations above, instrumentation precision is associated with at least one of a systematic error and an instability of at least one instrumental component of the metrology system.

In any one of the implementations above, the plurality of reference datasets are generated: via physical simulation based on the set of underlying metrology physical principles with the known reference values and known uncertainties of the target physical parameter; or by one or more calibration metrology systems based on the set of underlying metrology physical principles and having reference precisions higher than the instrumental precision of the metrology system.

In any one of the implementations above, the metrology system comprises an atomic point source interferometer disposed in a non-inertia reference frame; the target physical parameter comprises an angular rotation or linear acceleration of the non-inertia reference frame relative to an inertia reference frame; and the instrumentation precision of the atomic point source interferometer is associated with at least one of an imperfection in controlling a temperature of an atomic cloud of the atomic point source interferometer and controlling an optical manipulation of the atomic cloud with respect to an optical wavelength, an optical pulse area, and an optical geometric alignment.

In any one of the implementations above,a loss function for training the neural network comprises an optimization parameter representing measurement uncertainty of the target physical parameter, the optimization parameter being dependent on the plurality of reference datasets.

The description and accompanying drawings above provide specific example embodiments and implementations. Drawings containing device structure and composition, for example, are not necessarily drawn to scale unless specifically indicated. Subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, or systems. Accordingly, embodiments may, for example, take the form of hardware, software, firmware or any combination thereof.

The methods, devices, processing, and logic described above may be implemented in many different ways and in many different combinations of hardware and software. For example, all or parts of the implementations may be circuitry that includes an instruction processor, such as a Central Processing Unit (CPU), Graphical Processing Unit (GPU), micro controller, or a microprocessor; an Application Specific Integrated Circuit (ASIC), Programmable Logic Device (PLD), or Field Programmable Gate Array (FPGA); or circuitry that includes discrete logic or other circuit components, including analog circuit components, digital circuit components or both; or any combination thereof. The circuitry may include discrete interconnected hardware components and/or may be combined on a single integrated circuit die, distributed among multiple integrated circuit dies, or implemented in a Multiple Chip Module (MCM) of multiple integrated circuit dies in a common package, as examples.

The circuitry may further include or access instructions for execution by the circuitry. The instructions may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described above or illustrated in the drawings.

The implementations may be distributed as circuitry among multiple system components, such as among multiple processors and memories, optionally including multiple distributed processing systems. Parameters, databases, and other data structures may be separately stored and managed, may be incorporated into a single memory or database, may be logically and physically organized in many different ways, and may be implemented in many different ways, including as data structures such as linked lists, hash tables, arrays, records, objects, or implicit storage mechanisms. Programs may be parts (e.g., subroutines) of a single program, separate programs, distributed across several memories and processors, or implemented in many different ways, such as in a library, such as a shared library (e.g., a Dynamic Link Library (DLL)). The DLL, for example, may store instructions that perform any of the processing described above or illustrated in the drawings, when executed by the circuitry.

Throughout the specification and claims, terms may have nuanced meanings suggested or implied in context beyond an explicitly stated meaning. Likewise, the phrase “in one embodiment/implementation” or “in some embodiments/implementations” as used herein does not necessarily refer to the same embodiment and the phrase “in another embodiment/implementation” or “in other embodiments/implementations” as used herein does not necessarily refer to a different embodiment/implementation. It is intended, for example, that claimed subject matter may include combinations of example embodiments/implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

What is claimed:

1. A metrology method, comprising:
receiving a measurement dataset originated by a metrology system characterized by an instrumental precision and a set of underlying metrology physical principles;
retrieving a neural network configured to process the measurement dataset to generate a predicted value with predicted measurement uncertainty of a target physical parameter, the neural network being pre-trained based on a plurality of reference datasets for measuring the target physical parameter with known reference values and known uncertainties; and
forward-propagating the measurement dataset through the neural network to generate the predicted value with the predicted measurement uncertainty of the target physical parameter having a precision higher than indicated by the instrumental precision.

2. The metrology method of claim 1, wherein the instrumentation precision is associated with at least one systematic error of at least one instrumental component of the metrology system.

3. The metrology method of claim 1, wherein the instrumentation precision is associated with an instability of at least one instrumental component of the metrology system.

4. The metrology method of claim 1, wherein the plurality of reference datasets are generated via physical simulation based on the set of underlying metrology physical principles with the known reference values and known uncertainties of the target physical parameter.

5. The metrology method of claim 1, wherein the plurality of reference datasets are generated by one or more calibration metrology systems based on the set of underlying metrology physical principles and having reference precisions higher than the instrumental precision of the metrology system.

6. The metrology method of claim 1, wherein the metrology system comprises an atomic interferometer.

7. The metrology method of claim 6, wherein the measurement dataset comprises at least one atomic interferogram image.

8. The metrology method of claim 7, wherein the atomic interferometer comprises an atomic point source interferometer using an atomic cloud as a measurement medium.

9. The metrology method of claim 8, wherein the atomic interferometer is disposed in a non-inertia reference frame and the target physical parameter comprises an angular rotation or linear acceleration of the non-inertia reference frame relative to an inertia reference frame.

10. The metrology method of claim 9, wherein the instrumentation precision of the atomic interferometer is associated with at least an imperfection in controlling a temperature of the atomic cloud.

11. The metrology method of claim 9, wherein the instrumentation precision of the atomic interferometer is associated with at least an imperfection in controlling an optical manipulation of the atomic cloud in a generation of the measurement dataset.

12. The metrology method of claim 11, wherein the imperfection comprises at least one of an optical wavelength imperfection, an optical pulse area imperfection, and an optical geometric alignment imperfection.

13. The metrology method of claim 9, wherein the at least one atomic interferogram image comprises a set of sine and cosine images generated from a set of measured atomic from the metrology system with a predefined set of phase offsets.

14. The metrology method of claim 6, wherein the atomic interferometer is arranged in a Mach-Zehnder interferometry configuration.

15. The metrology method of claim 1, wherein a loss function for training the neural network comprises an optimization parameter representing measurement uncertainty of the target physical parameter, the optimization parameter being dependent on the plurality of reference datasets.

16. A computing system comprising a memory for storing instructions and a processor for executing the instructions to:
receive a measurement dataset originated by a metrology system characterized by an instrumental precision and a set of underlying metrology physical principles;
retrieve a neural network configured to process the measurement dataset to generate a predicted value with predicted measurement uncertainty of a target physical parameter, the neural network being pre-trained based on a plurality of reference datasets for measuring the target physical parameter with known reference values and known uncertainties; and
forward-propagate the measurement dataset through the neural network to generate the predicted value with the predicted measurement uncertainty of the target physical parameter having a precision higher than indicated by the instrumental precision.

17. The computing system of claim 16, the instrumentation precision is associated with at least one of a systematic error and an instability of at least one instrumental component of the metrology system.

18. The computing system of claim 16, wherein the plurality of reference datasets are generated:
via physical simulation based on the set of underlying metrology physical principles with the known reference values and known uncertainties of the target physical parameter; or
by one or more calibration metrology systems based on the set of underlying metrology physical principles and having reference precisions higher than the instrumental precision of the metrology system.

19. The computing system of claim 16, wherein:
the metrology system comprises an atomic point source interferometer disposed in a non-inertia reference frame;
the target physical parameter comprises an angular rotation or linear acceleration of the non-inertia reference frame relative to an inertia reference frame; and
the instrumentation precision of the atomic point source interferometer is associated with at least one of an imperfection in controlling a temperature of an atomic cloud of the atomic point source interferometer and controlling an optical manipulation of the atomic cloud with respect to an optical wavelength, an optical pulse area, and an optical geometric alignment.

20. The computing system of claim 16, wherein a loss function for training the neural network comprises an optimization parameter representing measurement uncertainty of the target physical parameter, the optimization parameter being dependent on the plurality of reference datasets.
